(19) United States
(12) Patent Application Publication
(10) Pub. No.: US 2025/0017202 A1
(43) Pub. Date: Jan. 16, 2025

(54) LONG-LASTING DISINFECTING COMPOSITIONS AND METHODS FOR LONG-LASTING DISINFECTION

(71) Applicant: Specialty Operations France, Lyon (FR)

(72) Inventor: Amit SEHGAL, Potomac, MD (US)

(21) Appl. No.: 18/700,248

(22) PCT Filed: Oct. 26, 2022
(86) PCT No.: PCT/EP2022/079883

§ 371 Date: Apr. 10, 2024

Related U.S. Application Data
(60) Provisional application No. 63/273,235, filed on Oct. 29, 2021.

(51) Int. Cl. A01N 25/10; A01N 25/02; A01N 25/30; A01N 33/12; A01P 1/00

(52) U.S. Cl. CPC A01N 25/10; A01N 25/02; A01N 25/30; A01N 33/12; A01P 1/00

(57) ABSTRACT

The present invention relates to compositions, preferably a hard surface treatment composition, comprising: at least a polymer comprising one or more types of monomer units selected from the group consisting at least one cationic or amphoteric monomer unit, a multifunctional organic acid, and a nonionic or amphoteric surfactant. The invention also refers to the use of such compositions for killing pathogens on a surface over an extended period of time by applying a long-lasting composition to the surface.

The present invention relates to compositions, preferably a hard surface treatment composition, comprising: at least a polymer comprising one or more types of monomer units selected from the group consisting at least one cationic or amphoteric monomer unit, a multifunctional organic acid, and a nonionic or amphoteric surfactant. The invention also refers to the use of such compositions for killing pathogens on a surface over an extended period of time by applying a long-lasting composition to the surface.

### BACKGROUND

Antimicrobial disinfectant compositions containing quaternary ammonium compounds are used to kill microorganisms, such as bacteria and viruses, on a variety of surfaces and in a number of applications. For instance, quaternary ammonium compounds are used in various antimicrobial disinfectant products, such as sanitizers, cleaners, and wipes to disinfect hard surfaces. In their generic form, antimicrobial quaternary ammonium compounds (a.k.a. “quats”) are characterized by having at least one cationic (i.e., positively charged) nitrogen atom often referred to as the “quaternary nitrogen atom” and a hydrophobic tail. The positively charged nitrogen atom in the quats help allow the compounds to adhere to the negatively-charged surface of microorganisms, and the hydrophobic tail can penetrate the membranes of the microorganisms. General mode of action of quats is by adsorption onto, and diffusion through the cell wall, binding to, and disruption/disorganisation of the cytoplasmic membrane with release of cytoplasmic constituents, thereby killing the microorganism. Quats can also disrupt the protein and lipid structures of viruses, especially enveloped viruses. In this respect, quaternary ammonium compounds can be highly effective in killing microorganisms, including bacteria and viruses. Antimicrobial disinfectant compositions containing quaternary ammonium compounds typically achieve a microbial kill at 99.9% or greater upon initial contact or within a few minutes after the initial contact.

Yet, as useful as quats are for killing microorganisms, many of the antimicrobial disinfectant products containing quaternary ammonium compounds are harsh and are coming under increased scrutiny due to concerns about safety. The quats may also present aquatic hazards when released in the environment in large quantities. Also, while effective in initially killing microorganisms, quaternary ammonium compounds can be easily wiped off or removed from surfaces by touching or contact. Further, re-soiling or contamination of the treated surface after the initial application of the quaternary ammonium-containing antimicrobial disinfectant products requires additional treatment with the product. In both instances, this leaves the treated surface susceptible to recontamination with microorganisms. Therefore, a need exists for antimicrobial disinfectant compositions that do not have quaternary ammonium compounds (i.e., compositions that are essentially “quat-free”), while also providing long-lasting disinfection properties. In particular, there is a need for antimicrobial disinfectant compositions that are essentially quat-free, while providing long-lasting disinfection properties for at least a work day or 12 to 24 hours or longer.

### SUMMARY

The present invention relates to compositions, preferably a hard surface treatment compositions, comprising: at least:
1. a polymer comprising one or more types of monomer units selected from the group consisting at least one cationic or amphoteric monomer unit, and optionally anionic monomer units or non-ionic monomer units, and combinations thereof, wherein the cationically charged atom of the cationic or amphoteric monomer unit, is not structurally an atom in the carbon chain backbone of the polymer and separated from the carbon chain backbone by at least one other carbon atom;
2. a multifunctional organic acid;
3. a nonionic or amphoteric surfactant comprising at least one nitrogen atom; and
4. from 0 to 100 ppm of any quaternary ammonium compound, preferably from 0 to 50 ppm.

Also presented are methods of providing a surface with residual antimicrobial action that include the step of applying a composition of the present invention to the surface. The invention relates also to a method for killing pathogens on a surface over an extended period of time, the method comprising a composition of the present invention to the surface.

The present invention also provides a substrate with residual antimicrobial action comprising a substrate wherein at least a portion of the substrate is coated with a composition of the present disclosure.

The compositions of the present invention wherein a film is formed from the compositions preferably kills at least 99.9% of microorganisms for at least 3 wear cycles according to RSS-12 h. The compositions of the present invention wherein a film is formed from the compositions preferably kills at least 99.9% of gram-positive bacteria and gram-negative bacteria, or enveloped and non-enveloped viruses according to Environmental Protection Agency (EPA) Protocol #01-1 A residual self-sanitizing activity test or EPA-RSS guidance for viruses.

### Definitions

Unless defined otherwise, all technical and scientific terms used herein have the same meaning as is commonly understood by one of skill in the art to which this specification pertains.

Throughout the description, including the claims, the term “comprising one” or “comprising a” should be understood as being synonymous with the term “comprising at least one”, unless otherwise specified, and “between” should be understood as being inclusive of the limits.

As used in the specification and claims, the singular form “a”, “an” and “the” includes plural references unless the context clearly dictates otherwise.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

As used herein, the terminology “(Cn-Cm)” in reference to an organic group, wherein n and m are each integers, indicates that the group may contain from n carbon atoms to m carbon atoms per group.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

“Alkyl” as used herein means a straight chain or branched saturated aliphatic hydrocarbon group and is intended to include both “unsubstituted alkyl” and “substituted alkyl”, the latter of which refers to alkyl moieties having substituents (such as hydroxyl group and halogen group) replacing a hydrogen on one or more carbon atoms of the alkyl group. Representative saturated straight chain alkyls include methyl, ethyl, n-propyl, n-butyl, n-pentyl, and the like; while saturated branched alkyls include isopropyl, sec-butyl, isobutyl, tert-butyl, isopentyl, and the like.

“Alkenyl”, as used herein, refers to an aliphatic group containing at least one double bond and is intended to include both “unsubstituted alkenyls” and “substituted alkenyls”, the latter of which refers to alkenyl moieties having substituents (such as hydroxyl group and halogen group) replacing a hydrogen on one or more carbon atoms of the alkenyl group. Representative unsaturated straight chain alkenyls include ethenyl, propenyl, butenyl, pentenyl, hexenyl, heptenyl, octenyl, nonenyl, decenyl and the like.

As used herein, the term “aryl” refers to a monovalent aromatic hydrocarbon group, including bridged ring and/or fused ring systems, containing at least one aromatic ring. Examples of aryl groups include phenyl, naphthyl and the like. The term “arylalkyl” or the term “aralkyl” refers to alkyl substituted with an aryl. The term “arylalkoxy” refers to an alkoxy substituted with aryl.

As used herein, the term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. As used herein, the term “cycloalkyl” as used herein means cycloalkyl groups containing from 3 to 8 carbon atoms, such as for example cyclohexyl. As used herein, the term “heterocyclic” as used herein means heterocyclic groups containing up to 6 carbon atoms together with 1 or 2 heteroatoms which are usually selected from O, N and S, such as for example radicals of: oxirane, oxirene, oxetane, oxete, oxetium, oxalane (tetrahydrofurane), oxole, furane, oxane, pyrane, dioxine, pyranium, oxepane, oxepine, oxocane, oxocinc groups, aziridine, azirine, azirene, azetidine, azetine, azete, azolidine, azoline, azole, azinane, tetrahydropyridine, tetrahydrotetrazine, dihydroazine, azine, azepane, azepine, azocane, dihydroazocine, azocinic groups and thiirane, thiirene, thiethane, thiirene, thietane, thiete, thietium, thiolane, thiole, thiophene, thiane, thiopyrane, thiine, thiinium, thiepane, thiepine, thiocane, thiocinic groups.

“Heterocyclic” may also mean a heterocyclic group fused with a benzene-ring wherein the fused rings contain carbon atoms together with 1 or 2 heteroatom's which are usually selected from N, O and S.

### DETAILED DESCRIPTION

The present disclosure relates to compositions that provide a longer lasting disinfection to treated surfaces and are free of non-ionic surfactants. The present compositions achieve microorganism (e.g. bacterial, viral, or fungal) kill of at least 95% or greater, (e.g. 99.9% kill), for at least 12 hours obviating the need for repeated treatment. In order to substantiate at typical 24 hour long-term sanitization claim with the United States Environmental Protection Agency (EPA), compositions are evaluated with the residual self-sanitization (RSS) method, EPA Protocol #01-1A (https://www.epa.gov/sites/production/files/2015-09/documents/cloroxpcol_final.pdf). For validating longer term disinfection, all extant test protocols emulate the maximum amount of recontamination and abrasion by touching and wiping anticipated before reapplication, typically a 24 hour period. An intermediate protocol with approximately half the level abrasion and re-soiling challenge to a surface is presented here as the “RSS-12 h” test protocol.

In an embodiment, a film formed from the composition kills at least 99.9% (e.g. log 3 reduction) of microorganisms according to the residual self-sanitizing (RSS) activity test (EPA Protocol #01-1A). In an embodiment, a film formed from the composition kills at least 99.9% (e.g. log 3 reduction) of gram-positive bacteria and gram-negative bacteria according to the residual self-sanitizing (RSS) activity test (EPA Protocol #01-1A).

Long lasting disinfection claims are substantiated by the RSS test, which challenges the applied composition by subjecting it to recontamination (re-inoculation with microorganisms) and abrasion (wear cycles). An intermediate test protocol, with approximately half the number of re-inoculations and wear cycles (“RSS-12 h”) is used to predict disinfection that is durable up to 12 hours before reapplication of the test product. As outlined in FIG. 1, this procedure requires preparation of the test bacterial (microbial) culture over the first week (see EPA Protocol #01-1A) followed by testing in week 2.

The testing involves inoculating the surface with bacteria, followed by application of the product on the substrate and allowing it to dry. The substrate may be glass, polycarbonate, or steel. This substrate is then subjected to an abrasion—re-inoculation regime of 3 “wear cycles”. The abrasion is conducted with a 1084 gwt. rectangular steel block covered with a cloth with an underlying thin polyurethane-foam layer. Each wear cycle is composed of a “dry” abrasion and a “wet” abrasion, the latter with the cloth cover having been wet with a mist of water using a Preval® sprayer. Each abrasion (dry/wet) is characterized by a back and forth motion of the block across the test substrate. Each abrasion cycle is followed by re-inoculation the surface with a bacterial culture. The RSS-12 h involves a 3-abrasion cycle/3-inoculations test as compared to the full RSS test that outlines a 6-abrasion cycle/6-inoculation test regimen. All other details of the test method are as outlined in the EPA Protocol #01-1A.

The test substrate is allowed to dry overnight and then finally inoculated again (sanitizer test) for 5 minutes, followed by neutralization of the entire substrate. Surviving bacteria is then harvested off the surface and cultured with serial dilutions on agar plates, allowing colony formation over 24-48 hours. Surviving bacteria are then counted as the number of colonies. The difference in bacterial count inoculated and surviving bacteria results in an efficacy evaluation in percent kill (e.g. 99.9% kill) or log-reduction (e.g. 3-log reduction) on a logarithmic scale. The bacteria in this test may be substituted for other microorganisms such as fungi or viruses. In an embodiment, microorganisms are selected from gram-positive bacteria (e.g Staphylococcus aureus), gram-negative bacteria (e.g. Enterobacter aerogenes), fungi, enveloped viruses, non-enveloped viruses, and combinations thereof.

The composition of the present disclosure is a liquid formulation. It is contemplated that one preferred method of making use of the composition of the present disclosure is to apply a layer of the composition to a substrate and dry the composition or allow it to dry. The act of applying a layer of the composition to a substrate and then drying it or allowing it to dry is known herein as “treating” the substrate. It is contemplated that, as the solvent evaporates, the composition will form a film on the substrate. The dried layer of the composition is known herein as “a film.”

In an embodiment, the composition includes:
1. a polymer comprising one or more types of monomer units selected from the group consisting at least one cationic or amphoteric monomer unit, and optionally anionic monomer units or non-ionic monomer units, and combinations thereof, wherein the cationically charged atom of the cationic or amphoteric monomer unit, if present, is not structurally an atom in the carbon chain backbone of the polymer and separated from the carbon chain backbone by at least one other carbon atom;
2. a multifunctional organic acid;
3. a nonionic or amphoteric surfactant comprising at least one nitrogen atom; and
4. from 0 to 100 ppm of any quaternary ammonium compound, preferably from 0 to 50 ppm.

The pH of the composition may range from about 0.5 to about 11, preferably 3 to 9. In another embodiment, the pH of the composition is less than 5. In another embodiment, the pH of the composition ranges from 2 to 4.9. In yet another embodiment, the pH of the composition ranges from 3 to 4.8. In an embodiment, the pH of the composition ranges from 0.5 to 3.

Polymer (1) of the invention comprises at least one or more types of monomer units selected from the group consisting at least one cationic or amphoteric monomer unit, and optionally anionic monomer units or non-ionic monomer units, and combinations thereof, wherein the cationically charged atom of the cationic or amphoteric monomer unit, if present, is not structurally an atom in the carbon chain backbone of the polymer and separated from the carbon chain backbone by at least one other carbon atom;

The synthetic polymer may include its homopolymer, copolymer, terpolymer, block copolymer, random polymer, linear polymer, comb polymer or branched polymer.

Any combination of these types of monomers may be used. For example, suitable polymers include but are not limited to those comprising, consisting of or consisting essentially of at least one cationic monomer unit or at least one amphoteric monomer unit, and optionally at least one anionic monomer units or at least one non-ionic monomer units, and combinations thereof.

As used herein, cationic monomers covers not only positively charged groups, but also groups which may become partially positively charged depending on the pH.

The cationic monomer may include an ammonium group of formula —NR3+, wherein R, which is identical or different, represents a hydrogen atom, an alkyl group comprising 1 to 10 carbon atoms, or a benzyl group, optionally carrying a hydroxyl group, and comprise an anion (counter-ion). Examples of anionic counter-ions are halides such as chloride and bromides, sulphates, hydrosulphates, alkylsulphates (for example comprising 1 to 6 carbon atoms), sulfonates, phosphates, carbonates, nitrates, citrates, formates, and acetates.

Examples of cationic monomer include, but are not limited to:

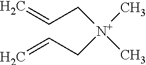

Diallyldimethylammonium halides such as diallyldimethylammonium chloride (DADMAC) or the corresponding bromide. Alternatively, the counter ion may be sulphate, nitrate, carbonate or phosphate. Similar momomer units, such as those in which one or more of the CH₃ groups is replaced by a C_{2 to 12} for example a C_{2 to 6} alkyl group or one or more of the CH₂ groups is replaced by an alkyl group having from 2 to 12, for example from 2 to 6 carbon atoms may be used. In other words, other similar commercially available monomers or polymers containing such monomers may be used.

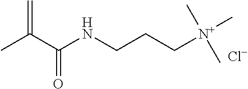

N,N,N-trimethyl-3-((2-methyl-1-oxo-2-propenyl)amino)-1-propanaminium halides, such as the chloride (MAPTAC, also known as methacryl-amido (propyl)-trimethyl ammonium chloride).

Additional examples of cationic monomer include, but are not limited to:
1. aminoalkyl (meth)acrylates, aminoalkyl (meth)acrylamides,
2. monomers, including particularly (meth)acrylates, and (meth)acrylamides derivatives, comprising at least one secondary, tertiary or quaternary amine function, or a heterocyclic group containing a nitrogen atom, vinylamine or ethylenimine;
3. diallyldialkyl ammonium salts;
4. their mixtures, their salts, and macromonomers deriving from therefrom;
5. dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
6. ethylenimine, vinylamine, 2-vinylpyridine, 4-vinylpyridine;
7. trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,
8 diallyldimethyl ammonium chloride,
9. monomers having the following formula A (II):

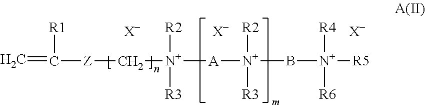

wherein R₁ is a hydrogen atom or a methyl or ethyl group; R₂, R₃, R₄, R₅ and R₆, which are identical or different, are linear or branched C₁-C₆, preferably C₁-C₄, alkyl, hydroxyalkyl or aminoalkyl groups; m is an integer from 0 to 10, for example 1; n is an integer from 1 to 6, preferably 2 to 4; Z represents a —C(O)O— or —C(O)NH— group or an oxygen atom; A represents a (CH₂)ₚ group, p being an integer from 1 to 6, preferably from 2 to 4; B represents a linear or branched C₂-C₁₂, typically C₃-C₆, polymethylene chain optionally interrupted by one or more heteroatoms or heterogroups, in particular O or NH, and optionally substituted by one or more hydroxyl or amino groups, preferably hydroxyl groups; X, which are identical or different, represent counterions, and their mixtures, and macromonomers deriving therefrom.

Other cationic monomers include compounds of general formula A (I):

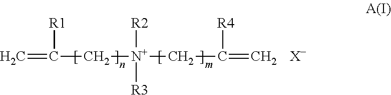

in which: R₁ and R₄, independently of each other, represent a hydrogen atom or a linear or branched C₁-C₆ alkyl group; R₂ and R₃, independently of each other, represent an alkyl, hydroxyalkyl or aminoalkyl group in which the alkyl group is a linear or branched C₁-C₆ chain, preferably a methyl group; n and m are integers between 1 and 3; X, which may be identical or different, represent counterions which are compatible with the water-soluble or water-dispersible nature of the polymer. In one embodiment, X is selected from the group of halide anions, sulfate anions, hydrogen sulfate anions, phosphate anions, carbonate anions, nitrate anions, citrate anions, formate anions, or acetate anions.

The polymers used in the present invention may have a polyampholyte structure such that the charge and surface adsorption are determined by pH. In an embodiment, the polymer is an acrylic acid amine-functional polymer. Examples of suitable hydrophilic polymers are described in U.S. Pat. Nos. 6,569,261, 6,593,288, 6,703,358 and 6,767,410, the disclosure of these documents is incorporated herein by reference. These documents describe water-soluble or water-dispersible copolymers including, in the form of polymerized units, (1) at least one amine-functional monomer, (2) at least one hydrophilic monomer with an acidic nature and (3) optionally at least one neutral hydrophilic monomer having an ethylenic unsaturation. The copolymers include quaternized ammonium acrylamide acid copolymers.

Examples of the anionic monomer include, but are not limited to, acrylic acid, methacrylic acid, α-ethacrylic acid, β,β-dimethacrylic acid, methylenemalonic acid, vinylacetic acid, allylacetic acid, ethylideneacetic acid, propylideneacetic acid, crotonic acid, maleic acid, fumaric acid, itaconic acid, citraconic acid, mesaconic acid, N-methacryloylalanine, N-acryloylhydroxyglycine, sulfopropyl acrylate, sulfoethyl acrylate, sulfoethyl methacrylate, sulfoethyl methacrylate, styrenesulfonic acid, vinylsulfonic acid, vinylphosphonic acid, phosphoethyl acrylate, phosphonoethyl acrylate, phosphopropyl acrylate, phosphonopropyl acrylate, phosphoethyl methacrylate, phosphonoethyl methacrylate, phosphopropyl methacrylate and phosphonopropyl methacrylate, and the ammonium and alkali metal salts of these acids. Preferably the polymer comprises an anionic monomer selected from the group consisting of acrylic acid, methacrylic acid, and combinations thereof.

Examples of the non-ionic monomer include, but are not limited to, 2-(Dimethylamino)ethyl methacrylate (DMAEMA),

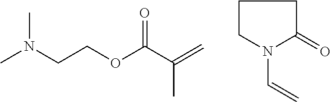

N-vinyl pyrrolidone (NVP), N-vinylimidazole, acrylamide, and

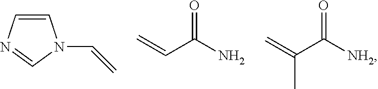

methacrylamide.
Examples of the amphoteric monomer include, but are not limited to, sulfobetaines and carboxybetaines such as: 3-dimethyl(methacryloyloxyethyl) ammonium propanesulfonate (DMAPS) also sometimes called poly(sulfobetaine methacrylate) (PSBMA), 3-Diethyl(methacryloyloxyethyl) ammonium propanesulfonate (DEAPS), N,N-Dimethyl(acrylamidopropyl) ammonium propanesulfonate (DMAAPS), N,N-Dimethyl(methacrylamidopropyl) ammonium propanesulfonate (DMMAAPS), poly(carboxybetaine methacrylate) (PCBMA) among others.
Amphoteric polymers such as poly(sulfobetaines) or poly(carboxybetaines) are typically synthesized by free radical polymerization isothermally as homopolymers or copolymers with other anionic, cationic or nonionic monomers. They can also be synthesized using reverse atom transfer radical polymerization.

An example of a polymer suitable for use in the composition of the present disclosure is a polymer comprising, consisting of or consisting essentially of DMAEMA, DADMAC, MAPTAC, acryclic acid and/or methylacrylic acid or combinations of the same.

Suitable polymers include those sold under the trade name Mirapol®, for example as Mirapol® Surf-SHO, Mirapol® Surf-S110, Mirapol® 100, Mirapol® Surf-S200, Mirapol® Surf-S210, Mirapol® HSC 310, or Mirapol® Surf-S500 available from Solvay, Novecare.

Other suitable polymers include polymers comprising, consisting of or consisting essentially of DADMAC and/or acrylamide, such as those sold under the trade name Polyquat® e.g. PQ6 or PQ7 from Surfacare, or the tradename SpecKare™ PQ-6, or under the trade name Merquat® S from Lubrizol. Other suitable polymers include polymers comprising, consisting of or consisting essentially of DADMAC and/or methacrylamide and/or, acrylic acid or methacrylic acid.

Polymers comprising, consisting of or consisting essentially of MAPTAC and acrylamide or methacrylamide are also suitable for use in the composition of the present disclosure. Also suitable are polymers comprising, consisting of or consisting essentially of MAPTAC and vinyl pyrrolidone, such as Polyquat® 28. Suitable polymers include those sold under the trade names Polyquart® Pro. (which is polyquat 28 plus silicone) and Polyquart® Ampo 140 from BASF.

Other suitable polymers include polymers comprising, consisting of or consisting essentially of MAPTAC and acrylic acid or methacrylic acid, such as those sold under the trade name Polyquat® Ampho, eg Polyquat® Ampho 149.

Polymers comprising, consisting of or consisting essentially of DMAEMA and vinylpyrrolidone are suitable for use in the composition of the present disclosure. An example of such a polymer is sold under the name PQ11 by BRB International.

Other suitable polymers include polymers comprising, consisting of or consisting essentially of DMAEMA and acrylamide, such as the polymer sold under the trade name Polyquat® 5.

Other suitable polymers comprising, consisting of or consisting essentially of sulfobetaines or carboxybetaines are suitable for use in the composition of the present disclosure.

In an embodiment, the molecular weight of the polymer ranges from about 30,000 g/mol to about 2 million g/mol, preferably 100,000 g/mol to 500,000 g/mol.

In an embodiment, the amount of polymer (1) in the composition ranges from about 200 ppm to 20000 ppm preferably 200 ppm to about 4,000 ppm. In the case of a concentrate, the dilution at use concentration would have the composition of the polymer in this range.

Compositions of the present invention further include one or more multifunctional organic acids (2), notably compounds having at least 2 carboxylic acid functions. The multifunctional organic acid (2) may be selected from the group consisting of, but not limited to: citric, malic, maleic, oxalic, glutaric, succinic, adipic, fumaric, malonic, tartaric, formic, itaconic, dipicolinic, iminodiacetic, glutamic, furan dicarboxylic and combinations thereof. The multifunctional organic acid may be present in its salt form.

In another embodiment, the counterion acid may be polymeric acid, such as, for example, poly(acrylic acid) or other polycarboxylic acids (e.g. maleic anhydride, methacrylic acid, etc.) or homopolymers or copolymers (e.g. methyl methacrylate, butyl acrylate, etc.) thereof, such as those in the Rhodoline® series available from Solvay. The composition may include from 100 to 10,000 ppm of one or more organic acids. In the case of a concentrate, the dilution at use concentration may have the composition of the organic acids in this range.

In another embodiment the multifunctional organic acids (2) may be mixed with other organic mono-functional acids such as but not limited to lactic, glycolic, acetic, benzoic, propionic, sorbic, ascorbic, caproic, octanoic, decanoic acid among others.

In compositions of the present invention, the surfactant is selected from nonionic and/or amphoteric surfactant comprising at least one nitrogen atom (3) and combinations thereof.

Compositions of the invention may comprise from 100 to 30000 ppm of nonionic or amphoteric surfactant comprising at least one nitrogen atom (3), preferably from 100 to 10000 ppm, even more preferably from 100 to 5000 ppm. In the case of a concentrate, the dilution factor would lead to a composition having 100 to 30000 ppm of the nonionic or amphoteric surfactant comprising at least one nitrogen atom (3) at use concentration.

Nonionic surfactants comprising at least one nitrogen atom (3) are preferably chosen in the group consisting of: surfactants with primary, secondary and/or tertiary nitrogen atom such as but not limited to: under the brand Triameen®, Armeen®, Ethomeen® (sold by Nouryon/Akzo), Fentacare®, Rhodameen®, Miramine®, Mackamide®, (sold by Solvay); or amine-oxide surfactants under the brand Mackamine®, Fentacare® (sold by Solvay), Ammonyx® (sold by Stepan), Aromox® (sold by Nouryon/Akzo) or Tomamine AO® (sold by Evonik) among many other suppliers.

Amphoteric surfactants contain both a basic and an acidic hydrophilic group and an organic hydrophobic group. Amphoteric surfactant comprising at least one nitrogen atom (3) are preferably chosen in the group consisting of: carboxybetaines, sulfobetaines, propionates, amphoacetates, sultaines, hydroxysultaines, or amino acid surfactants such as but not limited to taurates, glutamates, glycinates, aspartates or alaninates.

In an embodiment, when present, the nonionic or amphoteric surfactants (3) are pseudo cationic in the acidic pH conditions of the present disclosure. Pseudo cationic surfactant is selected from amine oxides, betaines, propionates, amphoacetates and combinations thereof. Amine oxides, propionates, amphoacetates and betaines are cationic. In an embodiment, the propionate is selected from cationic C₈-C₂₂ propionates and salts thereof. In another embodiment, the cationic C₈-C₂₂ propionate is selected from alkyl ampho(di)propionate, alkyl aminopropionates, alkyl amphopropionates, salts thereof, and combinations thereof. In an embodiment the cationic amphoacetate is selected from amphoacetates according to the following formula:

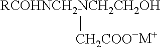

and diamphoacetates according to the following formula:

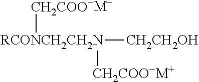

where R is an aliphatic group of 8 to 18 carbon atoms, and M is a cation such as sodium, potassium, ammonium, or substituted ammonium. Sodium lauroamphoacetate, sodium cocoamphoacetate, disodium lauroamphoacetate, and disodium cocoamphodiacetate are preferred in some embodiments.

In an embodiment, the betaine is selected from cationic C₈-C₂₂ betaines and salts thereof. In a further embodiment, the cationic C₈-C₂₂ betaine is selected from alkyl dimethylbetaines, alkylamidopropyl betaines, alkylampho(di)acetates, salts thereof, and combinations thereof. Where reference is made herein to “salts thereof” for cationic surfactants, these may be any suitable salts. In one embodiment the salt is a salt based on a monovalent cation, such as Na, K, or NH₄. In one embodiment, the salt is a salt based on an alkali metal, e.g. Na or K. The use of alternative salts, e.g. alkali earth metal salts such as Ca and Mg could also be contemplated; however the solubility of the product would need to be borne in mind when using such salts.

The compositions of the present invention comprises then from 0 to 100 ppm of any quaternary ammonium compound (4), preferably from 0 to 50 ppm. Preferably the composition is free of quaternary ammonium compound (4). As used herein, the terms “free of quaternary ammonium compound” refer to a composition, mixture, or ingredients that do not contain quaternary ammonium compounds.

The term “quaternary ammonium compound” (also referred to as “quat”) as used herein means a compound containing at least one quaternized nitrogen wherein the nitrogen atom is attached to four organic groups. The quaternary ammonium compound may comprise one or more quaternized nitrogen atoms. The term “quaternary ammonium compound” or “quat” generally refers to any composition with the following formula:

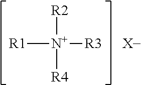

where R1-R4 are alkyl groups that may be alike or different, substituted or unsubstituted, saturated or unsaturated, branched or unbranched, and cyclic or acyclic and may contain ether, ester, or amide linkages; they may be aromatic or substituted aromatic groups. In an embodiment, groups R1, R2, R3, and R4 each have less than a C₂₀ chain length. X⁻ is an anionic counterion. The term “anionic counterion” includes any ion that can form a salt with quaternary ammonium. Examples of suitable counterions include halides such as chlorides, bromides, fluorides, and iodides, sulphonates, propionates, methosulphates, saccharinates, ethosulphates, hydroxides, acetates, phosphates, carbonates, bicarbonates, and nitrates. In an embodiment, the anionic counterion is chloride.

In some embodiments, quaternary ammoniums having carbon chains of less than 20 or C₂-C₂₀ are included in compositions of the present disclosure. In other embodiments, quaternary ammoniums having carbon chains of C₆-C₁₈, C₁₂-C₁₈, C₁₂-C₁₆ and C₆-C₁₀ are included in compositions of the present disclosure. Examples of quaternary ammonium compounds useful in the present disclosure include, but are not limited to, alkyl dimethyl benzyl ammonium chloride, alkyl dimethyl ethylbenzyl ammonium chloride, octyl decyl dimethyl ammonium chloride, dioctyl dimethyl ammonium chloride, and didecyl dimethyl ammonium chloride. A single quaternary ammonium or a combination of more than one quaternary ammonium may be included in compositions of the present disclosure. Further examples of quaternary ammonium compounds useful in the present disclosure include, but are not limited to, benzethonium chloride, ethylbenzyl alkonium chloride, ethyl benzethonium chloride, myristyl trimethyl ammonium chloride, methyl benzethonium chloride, cetalkonium chloride, cetrimonium bromide (CTAB), carnitine, dofanium chloride, tetraethyl ammonium bromide (TEAB), domiphen bromide, benzododecinium bromide, benzoxonium chloride, choline, denatonium, and mixtures thereof.

In some embodiments depending on the nature of the R group, the anion, and the number of quaternary nitrogen atoms present, the antimicrobial quaternary ammonium compounds may be classified into one of the following categories: monoalkyltrimethyl ammonium salts; monoalkyldimethylbenzyl ammonium salts; dialkyldimethyl ammonium salts; heteroaromatic ammonium salts; polysubstituted quaternary ammonium salts; bis-quaternary ammonium salts; and polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercial available under the tradenames Rhodaquat® M242C/29 and Dehyquart® A; alkyltrimethyl ammonium chloride, commercially available as Arquad® 16; alkylaryltrimethyl ammonium chloride; and cetyldimethyl ethylammonium bromide, commercially available as Ammonyx® DME.

Monoalkyldimethylbenzyl ammonium salts contain one R group that is a long-chain alkyl group, a second R group that is a benzyl radical, and the two remaining R groups are short-chain alkyl groups, such as methyl or ethyl groups. Some non-limiting examples of monoalkyldimethylbenzyl ammonium salts include alkyldimethylbenzyl ammonium chlorides, commercially available as Barquat® from Lonza Inc.; and benzethonium chloride, commercially available as Lonzagard®, from Lonza Inc. Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC® 2125M from Stepan Company, and Barquat® 4250 from Lonza Inc. Other examples include N,N-benzyldimethyloctylammonium chloride, N,N-benzyldimethyldecylammonium chloride, N-dodecyl-N-benzyl-N,N-dimethylammonium chloride, N-tetradecyl-N-benzyl-N,N-dimethylammonium chloride, N-hexadecyl-N,N-dimethyl-N-benzylammonium chloride, N,N-dimethyl N-benzyl N-octadecyl ammonium chloride.

Dialkyldimethyl ammonium salts contain two R groups that are long-chain alkyl groups, and the remaining R groups are short-chain alkyl groups, such as methyl groups. Some non-limiting examples of dialkyldimethyl ammonium salts include didecyldimethyl ammonium halides, commercially available as Bardac® 22 from Lonza Inc.; didecyl dimethyl ammonium chloride commercially available as Bardac® 2250 from Lonza Inc.; dioctyl dimethyl ammonium chloride, commercially available as Bardac® LF and Bardac® LF-80 from Lonza Inc.; and octyl decyl dimethyl ammonium chloride sold as a mixture with didecyl and dioctyl dimethyl ammonium chlorides, commercially available as Bardac® 2050 and 2080 from Lonza Inc.

Heteroaromatic ammonium salts contain one R group that is a long-chain alkyl group, and the remaining R groups are provided by some aromatic system. Accordingly, the quaternary nitrogen to which the R groups are attached is part of an aromatic system such as pyridine, quinoline, or isoquinoline. Some non-limiting examples of heteroaromatic ammonium salts include cetylpyridinium halide, commercially available as Sumquat® 6060/CPC from Zeeland Chemical Inc.; 1-[3-chloroalkyl]-3,5,7-triaza-1-azoniaadamantane, commercially available as Dowicil® 200 from The Dow Chemical Company; and alkyl-isoquinolinium bromide.

Polysubstituted quaternary ammonium salts are a monoalkyltrimethyl ammonium salt, monoalkyldimethylbenzyl ammonium salt, dialkyldimethyl ammonium salt, or heteroaromatic ammonium salt wherein the anion portion of the molecule is a large, high-molecular weight (MW) organic ion. Some non-limiting examples of polysubstituted quaternary ammonium salts include alkyldimethyl benzyl ammonium saccharinate, and dimethylethylbenzyl ammonium cyclohexylsulfamate.

Bis-quatemary ammonium salts contain two symmetric quaternary ammonium moieties having the general formula:

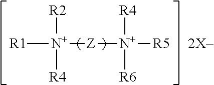

where the R groups may be long or short chain alkyl, a benzyl radical or provided by an aromatic system. Z is a carbon-hydrogen chain attached to each quaternary nitrogen. Some non-limiting examples of bis-quaternary ammonium salts include 1,10-bis(2-methyl-4-aminoquinolinium chloride)-decane; and 1,6-bis [1-methyl-3-(2,2,6-trimethyl cyclohexyl)-propyldimethylammonium chloride] hexane or triclobisonium chloride.

In an embodiment, the quaternary ammonium compound is a medium to long chain alkyl R group, such as from 8 carbons to about 20 carbons, from 8 carbons to about 18 carbons, from about 10 to about 18 carbons, and from about 12 to about 16 carbons, and providing a soluble and good antimicrobial agent.

In an embodiment, the quaternary ammonium compound is a short di-alkyl chain quaternary ammonium compound having an R group, such as from 2 carbons to about 12 carbons, from 3 carbons to about 12 carbons, or from 6 carbons to about 12 carbons.

Composition of the invention may also comprise polysaccharides, for example, cellulose, starch, xanthan gum, guars, hydropropyl guar, succinoglycan, and the like. Polysaccharides may be cationic polysaccharides, amphoteric or nonionic polysaccharides.

Cationic polysaccharides refer to polysaccharide or a derivative thereof that has been chemically modified to provide the polysaccharide or the derivative thereof with a net positive charge in a PH neutral aqueous medium. The cationic polysaccharide may also include those that are non permanently charged, e.g. a derivative that can be cationic below a given pH and neutral above that pH. Non-modified polysaccharides, such as starch, cellulose, pectin, carageenan, guars, xanthans, dextrans, curdlans, chitosan, chitin, and the like, can be chemically modified to impart cationic charges thereon. A common chemical modification incorporates quaternary ammonium substituents to the polysaccharide backbones. Other suitable cationic substituents include primary, secondary or tertiary amino groups or quaternary sulfonium or phosphinium groups. Additional chemical modifications may include cross-linking, stabilization reactions (such as alkylation and esterification), phophorylations, hydrolysis.

Nonionic polysaccharide refers to a polysaccharide or a derivative thereof that has been chemically modified to provide the polysaccharide or the derivative thereof with a net neutral charge in a PH neutral aqueous medium; or a non-modified polysaccharide.

Polysaccharides may have an average Molecular Weight (Mw) of between 100,000 daltons and 3,500,000 daltons, preferably between 100,000 daltons and 1,500,000 daltons, more preferably between 100,000 daltons and 1,000,000 daltons.

The compositions may comprise from 0.01 to 10 wt % of the polysaccharide, preferably from 0.05 to 5 wt %, based on the total weight of the composition.

In the context of the present application, the term “Degree of Substitution (DS)” of polysaccharides is the average number of hydroxyl groups substituted per sugar unit. DS may notably represent the number of the functional group substitutions per sugar unit. DS may be determined by titration. In one embodiment, the DS of the polysaccharides is in the range of 0.01 to 1. In another embodiment, the DS of the polysaccharides is in the range of 0.05 to 1, preferably in the range of 0.05 to 0.2.

In the context of the present application, “Charge Density (CD)” of polysaccharides means the ratio of the number of positive charges on a monomeric unit of which a polymer is comprised to the molecular weight of said monomeric unit. The CD of the polysaccharides may be in the range of 0.1 to 3 (meq/gm), preferably in the range of 0.1 to 2 (meq/gm).

Compositions of the invention, preferably hard surface treatment compositions, at use concentrations may comprise at least:
1. from 200 ppm to 20000 ppm of a polymer comprising one or more types of monomer units selected from the group consisting at least one cationic or amphoteric monomer unit, and optionally anionic monomer units or non-ionic monomer units, and combinations thereof, wherein the cationically charged atom of the cationic or amphoteric monomer unit, if present, is not structurally an atom in the carbon chain backbone of the polymer and separated from the carbon chain backbone by at least one other carbon atom;
2. from 100 to 10,000 ppm of a multifunctional organic acid;
3. from 100 to 30000 ppm of nonionic or amphoteric surfactant comprising at least one nitrogen atom; and
4. from 0 to 100 ppm of any quaternary ammonium compound, preferably from 0 to 50 ppm.

In addition to the components described herein, the composition may also include a polar solvent, such as a polar carrier solvent (e.g. water), fragrance, preservative, dye, corrosion inhibitor, builder, cleansing solvent and other components known to be useful in antimicrobial compositions.

Compositions of the invention may be obtained by various means available by a person skilled in the art. Composition may be notably obtained by adding sequentially its various components in an aqueous medium, with gentle mixing in water.

The compositions according to the present disclosure include both disinfectant cleaning compositions and concentrates which only differ in the relative proportion of water to that of the other constituents. In an embodiment, concentrated formulations include at least one quaternary ammonium compound in an amount ranging from about 800 ppm to about 80,000 ppm; or about 4,000 ppm to about 30,000 ppm; or about 10,000 ppm to about 25,000 ppm; a synthetic polymer in an amount ranging from about 800 ppm to about 50,000 ppm; or about 2,000 ppm to about 25,000 ppm; or about 4,000 ppm to about 20,000 ppm; a multifunctional organic acid in an amount ranging from about 1,000 ppm to about 60,000 ppm; or about 5,000 ppm to about 25,000 ppm; or about 15,000 ppm to about 25,000 ppm; a surfactant selected from nonionic surfactants and/or amphoteric surfactants comprising at least one nitrogen atom and combinations thereof in an amount ranging from about 2,000 ppm to about 100,000 ppm; or about 10,000 ppm to about 75,000 ppm; or about 20,000 ppm to about 70,000 ppm.

The concentrate can be used without dilution (concentrate:water 1:0) to extremely dilute dilutions (e.g., 1:10,000). In an embodiment, a range of dilution is from about 1:1 to about 1:1,000. In another embodiment, a range of dilution is from about 1:1 to about 1:500. In yet another embodiment, a range of dilution is from about 1:10 to about 1:128. The concentrates when diluted would provide compositions at use concentrations as as listed above.

Also disclosed are methods of providing a surface with residual antimicrobial action that includes the step of applying a composition of the present disclosure to the surface.

The composition may be applied to a surface by any method, including methods conducted by hand and methods conducted by machine and combinations thereof. For example, composition may be applied by spraying (pump, aerosol, pressure, etc.), pouring, spreading, metering (for example, with a rod or bar), mopping, wiping, brushing, dipping, mechanical application, other application methods, or combination thereof.

In an embodiment, compositions of the present disclosure are suited for use in a “spray and wipe” application. In such an application, the user generally applies an effective amount of the cleaning composition using the pump and within a few moments thereafter, wipes off the treated area with a rag, towel, or sponge, usually a disposable paper towel or sponge.

Compositions of the present disclosure, whether as described herein or in a concentrate or super concentrate form, can also be applied to a hard surface by using a wet wipe. The wipe can be of a woven or non-woven nature. Fabric substrates can include non-woven or woven pouches, sponges, in the form of abrasive or non-abrasive cleaning pads. Such fabrics are known commercially in this field and are often referred to as wipes. Such substrates can be resin bonded, hydroentangled, thermally bonded, meltblown, needlepunched, or any combination of the former.

The non-woven fabrics may be a combination of wood pulp fibers and textile length synthetic fibers formed by well-known dry-form or wet-lay processes. Synthetic fibers such as rayon, nylon, orlon and polyester as well as blends thereof can be employed. The wood pulp fibers should comprise about 30 to about 60 percent by weight of the non-woven fabric, preferably about 55 to about 60 percent by weight, the remainder being synthetic fibers. The wood pulp fibers provide for absorbency, abrasion and soil retention whereas the synthetic fibers provide for substrate strength and resiliency.

The compositions of the present disclosure are absorbed onto the wipe to form a saturated wipe. The wipe can then be sealed individually in a pouch which can then be opened when needed or a multitude of wipes can be placed in a container for use on an as needed basis. The container, when closed, sufficiently sealed to prevent evaporation of any components from the compositions.

Also provided are substrates with residual antimicrobial action that include a substrate wherein at least a portion of the substrate is coated with a composition of the present disclosure. The formulation of the present disclosure may be put to use by application any substrate. Some suitable substrates include, for example, countertops, mirrors, sinks, toilets, light switches, doorknobs, walls, floors, ceilings, partitions, railings, computer screens, keyboards, instruments, etc. Suitable substrates may be found in various settings including, for example, food preparation areas, households, industrial settings, architectural settings, medical settings, sinks, toilets, etc. Substrates may be made of any material; some suitable substrate compositions include, for example, plastic (including, for example, laminates and wall coverings), Formica, metal, glass, ceramic tile, paper (such as, for example, wallpaper), fabric, finished or unfinished wood, etc.

Also provided is the use of a composition of the present disclosure to substantially reduce or control the formation of microbial colonies on or at a surface over a prolonged period of time. In an embodiment, a film formed from the composition kills at least 95% of microorganisms for at least 3 abrasion cycles (alternating 3 wet and 3 dry) according to RSS-12 h. In another embodiment, a film formed from the composition kills at least 95% of microorganisms according to Environmental Protection Agency (EPA) Protocol #01-1A residual self-sanitizing activity test (e.g. 6 abrasion cycles wet and dry each and alternating for a 24 hour claim). In another embodiment, a film formed from the composition kills at least 99.9% of microorganisms for at least 3 abrasion cycles (alternating 3 wet and 3 dry) according to RSS-12 h. In yet another embodiment, a film formed from the composition kills at least 99.9% of microorganisms according to Environmental Protection Agency (EPA) Protocol #01-1A residual self-sanitizing activity test (e.g. 6 abrasion cycles wet and dry each and alternating for a 24 hour claim).

In an embodiment, a film formed from the composition kills at least 95% of at least one species of or a combination of gram-positive bacteria and gram-negative bacteria, fungi, or enveloped and non-enveloped viruses for at least 3 abrasion cycles (alternating 3 wet and 3 dry) according to RSS-12 h. In another embodiment, a film formed from the composition kills at least 95% of at least one species of or a combination of gram-positive bacteria and gram-negative bacteria, fungi, or enveloped and non-enveloped viruses according to Environmental Protection Agency (EPA) Protocol #01-1A residual self-sanitizing activity test (e.g. 6 abrasion cycles wet and dry each and alternating for a 24 hour claim). In another embodiment, a film formed from the composition kills at least 99.9% of at least one species of or a combination of gram-positive bacteria and gram-negative bacteria, fungi, or enveloped and non-enveloped viruses for at least 3 abrasion cycles (alternating 3 wet and 3 dry) according to RSS-12 h. In yet another embodiment, a film formed from the composition kills at least 99.9% of at least one species of or a combination of gram-positive bacteria and gram-negative bacteria, fungi, or enveloped and non-enveloped viruses according to Environmental Protection Agency (EPA) Protocol #01-1A residual self-sanitizing activity test (e.g. 6 abrasion cycles wet and dry each and alternating for a 24 hour claim).

While specific embodiments are discussed, the specification is illustrative only and not restrictive. Many variations of this disclosure will become apparent to those skilled in the art upon review of this specification.

The present disclosure will further be described by reference to the following examples. The following examples are merely illustrative and are not intended to be limiting.

### EXPERIMENTAL PART

### Example 1—Evaluation of Film Residual Biocidal Activity: EPA Protocol

Films prepared from Formulations A-C(Table 1) were evaluated using RSS-12 h protocol as described above, a modified version the residual self-sanitization (RSS) method, EPA Protocol #01-1A. All the films were prepared by pipetting 150 microliters of the formulations on a (1×1) inch stainless steel substrate and allowed to air dry.

Formulations have been obtained by adding, sequentially, its various components in water and mixing. Formulations have all a clear appearance.

TABLE 1

| | | Comparative | Comparative | Example | Example |
|---|---|---|---|---|---|
| | Description of | Example A | Example B | C | D |
| Components | Component | (ppm) | (ppm) | (ppm) | (ppm) |
| Decylamine | Non-ionic | | 2700 | 2700 | 2700 |
| oxide | surfactant | | | | |
| Citric acid | Multi- | | 3600 | 3600 | 2400 |
| | functional | | | | |
| | organic acid | | | | |
| Lactic acid | Organic acid | 7200 | 800 | 800 | |
| Polymer I | Synthetic | 800 | 400 | 400 | 800 |
| | copolymer of | | | | |
| | cationic and | | | | |
| | anionic | | | | |
| | monomers | | | | |
| Quat 1 | ADBAC | 200 | 2000 | | |
| Quat 2 | DDAC | 800 | 7800 | | |
| Glutamic acid | Chelating | | 800 | 800 | 800 |
| diacetic acid, | agent | | | | |
| tetrasodium salt | | | | | |
| Dodecyl | Non-ionic | 4000 | | | |
| dipropylene | surfactant | | | | |
| triamine | | | | | |
| Ethylenediamine | Chelating | 3000 | | | |
| tetraacetic | Agent | | | | |
| acid, disodium | | | | | |
| salt | | | | | |
| (EDTA—Na2) | | | | | |
| Polyoxyalkene | | 2000 | | | |
| alcohol | | | | | |
| % Actives | | 1.8 | 1.81 | 0.83 | 0.67 |
| pH of Sample | | 7.7 | 4.45 | 4.52 | 4.2 |
| Tested | | | | | |
| Amount (μL) | | 150 | 150 | 150 | 150 |
| Log Reduction | | <3.00 | 4.31 | 4.14 | 4.19 |
| RSS 6, 12, 24 or | | 12 | 12 | 12 | 12 |
| san. | | | | | |

Protocol #01-1A is a method approved by the EPA for measuring long-term sanitization claims (i.e., “kill later” durability claim). Protocol #01-1A, the entire contents of which are incorporated by reference, measures the residual self-sanitizing activity of dried chemical residues (films) on inanimate, hard, non-porous surfaces against bacteria e.g. Staphylococcus aureus, Klebsiella pneumoniae, and/or Enterobacter aerogenes. The example above shows the results with Enterobacter aerogenes which is usually the toughest to pass among the three listed microorganisms. In particular, surfaces are inoculated, treated with test product, allowed to dry, then abraded under alternating wet and dry conditions, which are interspersed with several re-inoculations.

Comparative example A contains two quaternary ammonium compounds, but nevertheless showed poor performance (log reduction less than 3). Formulation A is furthermore not abrasion resistant and fails RSS-12 h. The absence of the multifunctional organic acid is critical for performance. Comparative example B passes RSS-12 h but requires a high amount of quaternary ammonium compounds to perform. In comparison, Example C provides a robust formulation which passes RSS-12 h (log reduction greater than 3) without any quaternary ammonium compounds. The absence of quat appears hence to be immaterial to the final performance metric with the right formulations of the invention. Example D achieves 4.19 LR with RSS-12 h and further confirms that removing the lactic acid may be immaterial to the final performance, when coupled with formulation of the comparative example A suggests that an excess may impact be deleterious to long lasting disinfection.

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

1. A composition comprising: at least:
1. a polymer comprising one or more types of monomer units selected from the group consisting at least one cationic or amphoteric monomer unit, and optionally anionic monomer units or non-ionic monomer units, and combinations thereof, wherein the cationically charged atom of the cationic or amphoteric monomer unit, is not structurally an atom in the carbon chain backbone of the polymer and separated from the carbon chain backbone by at least one other carbon atom;
2. a multifunctional organic acid;
3. a nonionic or amphoteric surfactant comprising at least one nitrogen atom; and
4. from 0 to 100 ppm of any quaternary ammonium compound, preferably from 0 to 50 ppm.

2. The composition according to claim 1, wherein a film formed from the composition kills at least 99.9% of microorganisms for at least 3 wear cycles according to RSS-12 h.

3. The composition according to claim 1, wherein the cationic monomer is selected from the group consisting of diallyldimethylammonium halides.

4. The composition according to claim 1, wherein the amphoteric monomer is selected from the group consisting of sulfobetaines and carboxybetaines.

5. The composition according to claim 1, wherein the polymer (1) comprises an anionic monomer selected from the group consisting of acrylic acid, methacrylic acid, and combinations thereof.

6. The composition according to claim 1, wherein the polymer (1) comprises a non-ionic monomer selected from the group consisting of 2-(dimethylamino)ethyl methacrylate (DMAEMA); N-vinyl pyrrolidone (NVP); N-vinylimidazole; acrylamide; methacrylamide; and combinations thereof.

7. The composition according to claim 1, wherein the multifunctional organic acid (2) is selected from the group consisting of citric, malic, maleic, oxalic, glutaric, succinic, adipic, fumaric, malonic, tartaric, formic, itaconic, dipicolinic, iminodiacetic, glutamic, furan dicarboxylic and combinations thereof.

8. The composition according to claim 1, wherein the nonionic surfactant comprising at least one nitrogen atom (3) is selected from the group consisting of surfactants with primary, secondary and/or tertiary nitrogen atom.

9. The composition according to claim 1, wherein the amphoteric surfactant comprising at least one nitrogen atom (3) is selected from the group consisting of carboxybetaines, sulfobetaines, propionates, amphoacetates, sultaines, hydroxysultaines, or amino acid surfactants.

10. The composition according to claim 1, wherein the composition further comprises a polar solvent.

11. The composition according to claim 1, wherein the composition further comprises polysaccharides.

12. The composition according to claim 1, wherein the composition comprises from 200 ppm to 20000 ppm of the polymer (1).

13. The composition according to claim 1, wherein the composition comprises from 100 to 10,000 ppm of the multifunctional organic acid (2).

14. The composition according to claim 1, wherein the composition comprises from 100 to 30000 ppm of the nonionic or amphoteric surfactant comprising at least one nitrogen atom (3).

15. The composition according to claim 1, wherein a film formed from the composition kills at least 99.9% of gram-positive bacteria and gram-negative bacteria, or enveloped and non-enveloped viruses according to Environmental Protection Agency (EPA) Protocol #01-1A residual self-sanitizing activity test or EPA-RSS guidance for viruses.

16. A method of providing a surface with residual antimicrobial action that comprises the step of applying the composition according to claim 1 to the surface.

17. A substrate with residual antimicrobial action comprising a substrate wherein at least a portion of the substrate is coated with the composition according to claim 1.

18. A method for killing pathogens on a surface over an extended period of time, the method comprising a composition the composition according to claim 1.
